(19) United States
(12) Patent Application Publication
(10) Pub. No.: US 2015/0137412 A1
(43) Pub. Date: May 21, 2015

(54) Method of using additive materials for production of fluid flow channels

(71) Applicant: Carl Schalansky, Sacramento, CA (US)

(72) Inventor: Carl Schalansky, Sacramento, CA (US)

(21) Appl. No.: 14/549,326

(22) Filed: Nov. 20, 2014

Related U.S. Application Data
(60) Provisional application No. 61/906,746, filed on Nov. 20, 2013.

(51) Int. Cl. B29C 67/00

(52) U.S. Cl. CPC B29C 67/0055; B29L 2009/00
USPC 264/129

(57) ABSTRACT

An additive manufacturing process is described that is particularly useful in the production of compact heat exchangers, chemical reactors, static chemical mixers and recuperators.

### CROSS REFERENCE TO RELATED APPLICATIONS

In accordance with 37 C.F.R. 1.76, a claim of priority is included in an Application Data Sheet filed concurrently herewith. Accordingly, the present invention claims priority to U.S. Provisional Patent Application No. 61/906,746, entitled “METHOD OF USING ADDITIVE MATERIALS FOR PRODUCTION OF FLUID FLOW CHANNELS”, filed Nov. 20, 2013. The contents of which the above referenced application is incorporated herein by reference.

### FIELD OF THE INVENTION

This invention is directed generally toward the field of heat exchangers, chemical reactors and recuperators employing a plurality of fluid flow channels; and more particularly to heat exchangers, chemical reactors and recuperators and methods of making heat exchangers, chemical reactors and recuperators using an additive process.

### BACKGROUND OF THE INVENTION

Often, an operating machine or electronic component or other system generates waste heat in the course of its normal operation. If this waste heat is not removed, degraded performance or damage to the system may result. Frequently, the operating temperature of a system needs to be precisely maintained in order to obtain optimal performance. For instance, analytical instruments may require that the sample to be analyzed be presented to the instrument at a precisely controlled temperature. Heat exchangers permit heat to be removed or added to the sample as may be desired. A common type of heat exchanger is referred to as a “heat sink;” also called a “single-sided heat exchanger”. A heat sink typically transfers heat between a solid object and some fluid media, which may be a liquid, air or other gasses. Computer microprocessors frequently employ heat sinks to draw heat from the processor to the surrounding air, thereby cooling the microprocessor. Fins are often provided to increase the surface area of the heat sink to the air thereby increasing the efficiency of the heat sink. Such a heat sink could also comprise a closed fluid system. For example, a recirculating liquid coolant might be used to transfer heat from that portion of the heat sink in contact with the heat-generating device to a remotely located radiator. Another type of heat exchanger employs at least two fluids. In this type of heat exchanger, heat is transferred from a first fluid to a second fluid without direct contact between the fluids. For example, a fluid-to-fluid heat exchanger for a blood processing machine may employ heated water to warm the blood to the desired temperature. The blood circulating path is completely separate from that of the water circulating path and dilution or contamination of the blood is thus avoided. Other types of heat exchangers include those designed to recover waste heat from systems that produce excess or otherwise unusable heat. Such systems are often referred to as recuperators. One example of a recuperator is a passenger compartment heater that derives heat from an automobile engine. Another example is a liquid rocket exhaust nozzle that employs a series of small fluid channels to pre-heat fuel or oxidizer. A chemical reactor might employ a similar structure of channels such that the reactants may be catalyzed and process heat removed in a combined heat exchanger/chemical reactor multi-channel device. In all of these examples it is desirable that the precise structure of the flow channels be controllable so the device may operate efficiently within the desired parameters.

Traditional methods of producing heat exchangers and the like typically involve assembly of a plurality of pre-formed specific components. A thermal radiator for an internal combustion engine may comprise inlet and outlet manifolds. Said manifolds being produced from metal or plastic and having been machined, formed or molded to the desired shape. A plurality of heat exchanging flow tubes is situated between these manifolds that provide a large surface area from which heat is removed typically through convection. Such designs include “tube and shell” heat exchangers. The flow tubes may be formed by welding, drawing, extrusion or any other suitable method. Fin structures may be added to further enhance heat transfer to a fluid heat transfer medium. Other components such as side caps and mounting brackets may also be attached to facilitate the utility of the device.

A known method for producing compact and highly efficient heat exchangers uses very precise and complex fluid flow structures comprising a plurality of stacked and bonded laminar elements. These types of compact heat exchangers are often referred to as Printed Circuit Heat Exchangers, or PCHE. In these structures, each layer of the stack is configured to a pre-determined shape and precisely aligned with other elements in the stack. Similar to the structure of a laminated padlock, through-holes or partial depth voids (channels) in the element of one layer may align with mating holes or voids in adjacent elements. By carefully controlling the relative position of the through holes and channels (or other voids) of each layer, intricate, three-dimensional channels and passages may be created within the stack structure. Frequently, such structures are produced in the following manner. A series of laminar elements, often referred to as shims, sheets, or platelets is produced in which a series of holes, slots, channels, or other shapes exist in the face(s) of, or through the element. The laminar element may be produced by sawing, punching, fine-blanking, coining, and water-jet or laser cutting or other means of material removal. A common method of producing very precise and complex through-hole and grooved-channel metal sheet laminar elements employs photochemical machining. In this process, acids or other chemicals are used to etch away material from a solid, thin plate to produce the desired holes and other shapes. The etching process may be 100% i.e. completely through the plate or, the process may be controlled to etch only partially through the plate, for example, 50% or halfway through the plate. When a series of these plates are stacked as previously described, a three-dimensional structure replete with complex fluid flow channels and other useful structures may be realized. Heat exchangers produced in this manner are sometimes referred to as Printed Circuit Heat Exchangers or PCHE. Joining the plates together may be accomplished by the use of adhesives, brazing or welding or other known bonding methods. A preferred bonding method, particularly for severe service structures which must operate under extreme temperature, pressure and corrosive environments, is that of diffusion bonding or variants such as transient liquid phase diffusion bonding (TLP DB) or diffusion brazing. The diffusion bonding process is well known and will not be elaborated upon.

Production processes using variously formed heat exchanger components require complex and expensive, special purpose tooling. Additionally, a number of unrelated fabrication and assembly processes must be employed. Since the tooling and processes required are often extremely part specific, it can be very expensive and time consuming to implement even a small design change. Additionally, since the production process usually relies on material removal, such as punching, or sawing, a considerable amount of waste material is created which must be recycled or discarded, potentially creating environmental issues. The process of using stacked, laminar elements as described previously, suffers from the same issues in that tooling is frequently very specific to a particular part and is not readily re-purposed. If photochemical machining is employed, less purpose-built tooling may be required as the etch pattern and exposure mask can be digitally generated. However, this flexibility is not without problems. The etching process employed uses corrosive materials, typically strong acids or bases. Further, effluent from the photomask development and removal and from etching and subsequent washing process contains not only strong chemicals but also dissolved metals that must be properly recovered, recycled or otherwise disposed of. This recycling/disposal is often complex and expensive.

The process of the instant invention overcomes many of the shortcomings of previous processes, particularly with respect to costly dedicated tooling and the generation of toxic waste materials. Significantly, an additive process variant enables reduced bonding process equipment costs and enables a multiple material selection at any useful place on the platelet surface. Multiple materials and multiple material forms are possible and useful in application.

### BRIEF DESCRIPTION OF THE FIGURES

FIG. 1A is a perspective exploded view of structure having a plurality of fluid flow channels configured using an additive material process;

FIG. 1B is a close up view of a component of the structure having a plurality of fluid flow channels configured using an additive material process illustrated in FIG. 1A;

FIG. 1C is a perspective view of an assembly of the structure having a plurality of fluid flow channels configured using an additive material process illustrated in FIG. 1A;

FIG. 2 is a perspective view of a structure having a plurality of fluid flow channels configured using an additive material process formed by a wire printing process;

FIG. 3 is a perspective view of a structure having a plurality of fluid flow channels using an additive material process and formed having an offset stacked structure;

FIG. 4 is a perspective view of a non-dense structure having a plurality of fluid flow channels using an additive material process;

FIG. 5 illustrates a porous structure having a plurality of fluid flow channels using an additive material process;

FIG. 6 is a perspective view of a porous structure having a plurality of fluid flow channels using an additive material process being applied to a substrate;

FIG. 7 is a cross sectional view of a heat exchanger having a plurality of fluid flow channels using an additive material process;

FIG. 8A illustrates the first step in the formation of a first layer of a first and second structure which provides a fluid flow channel;

FIG. 8B illustrates the formation of a second layer in the formation of a first and second structure which provides a fluid flow channel;

FIG. 8C illustrates the formation of a third layer in the formation of a first and second structure which provides a fluid flow channel;

FIG. 8D illustrates a perspective view of an illustrative embodiment of the first and second structure which provides a fluid flow channel described in FIGS. 8A-8C.

### SUMMARY OF THE INVENTION

An additive material process is employed to produce a structure that may find utility in heat sinks, heat exchangers, recuperators, chemical reactors and other systems requiring a plurality of pre-determined fluid passages. The processes of furnace bonding or diffusion bonding are well suited to the production of the laminar stacks previously described. The processes are precise, efficient and highly scalable. Additionally, these processes produce virtually no waste materials and employ a minimum of specialized fixturing. By utilizing an additive process in concert with conventional sheet stock to produce the laminar elements to be bonded, virtually all the waste materials of the entire process may be eliminated. Here the additive material is deposited on conventional sheet material in the pattern desired. The sheet stock is held flat and kept cool during the additive process by use of a vacuum or electrostatic or magnetic chuck or by another method. Additionally, the expensive and purpose-built tooling of previous production methods is not required. Further, since the exact geometry produced by many of the additive production processes is essentially software defined, design changes may be easily and quickly implemented. This is particularly useful if an iterative design process is being employed in which a series of different designs are to be produced and compared for efficacy. The resultant structures of additive processes suitable for production of devices such as heat exchangers and the like generally fall into two categories. The deposited structures may be dense or they may be less than fully dense and hence, more compliant and deformable than dense structures. In dense structures, the deposited structural material is at or very near its theoretical maximum density, having virtually no unintentional voids. In deformable structures, interstitial spaces will be present to some degree and tend to increase the compliance or plasticity of the structure. Dense structure additive processes that find application in the instant invention include, but are not limited to, ultrasonic 3-D deposition sometimes referred to as Ultrasonic Additive Manufacturing (UAM), Cold Spray, sometimes referred to as 3-D painting, Selective Laser Sintering (SLS), Alloy Tape Application, and Densified Silk Screening. In densified material application, such as by silk screening, a slurry of viscous material is deposited by screening. Other techniques of compliant material application include CNC extrusion, powdered tape application, or a similar process to produce a 3-dimensional structure. To be densified structures they may be fired in vacuum, reducing atmosphere or otherwise controlled atmosphere to yield the desired platelet pattern. Another method of producing dense structures employs “Solid Wire Plotting” in which a wire is simultaneously fed and bonded to a substrate while under computerized numerical control. The solid wire process is similar to Fused Deposition Modeling (FDM).

Non-densified deformable structure processes that find application in the instant invention include, but are not limited to, Silk Screening or CNC Extrusion without densification and die-cut powdered paste which may be a pure material, any alloy or a mixture of low melting point metals and a high melting point material, typically powdered. The degree of densification may be controlled by particle size, particle size distribution, percentage of any binder present, percentage of any filler alloy present, firing temperature and application of force during and after any sintering and bonding process. If desired, a porous structure may be created, through which fluids may flow. This may be desirable to increase surface area to improve heat transfer or increase active sites in a reactor. The degree of porosity may also be controlled by at least partially filling any interstitial spaces with an additional material either during or after the sintering process.

With the exception of the solid wire process, any of the other mentioned deformable additive processes may be employed to create a micro-porous structure if desired. The solid wire process may be used to create a macro-porous structure.

A beneficial feature of dense structures produced using any of the additive processes is that conventional and well-known diffusion bonding processes may be employed. Deformable structures produced by additive processes may be bonded using low force modified diffusion bonding or variations. Here again, the desirable features and benefits of diffusion bonding may be realized. In the case of liquid phase sintering, it is possible in some cases to combine the sintering process and the desired bonding to a sheet substrate in one operation or, at least, a ramped time and temperature operation.

A preferred structure of the invention comprises a substrate, which may or may not be planar, onto which is deposited the additive 3-D structure. The deformable nature of the structure is, through suitable processing, solidified and becomes dense and non-deformable. Diffusion bonding of conventional dense structures is well established. Heat exchangers using dense structures are processed through control of time, temperature and applied forces (pressure applied to faying surfaces) to complete bonding and hence create a suitably solid structure. Force application is a very costly portion of the entire processing costs due to the substantial force-distributing tooling (often used are large precision machined graphite or refractory metal or ceramic platens), and extra processing time to heat and cool tooling platens. The furnace utilized to apply force to the assemblies being bonded is costly in large part due to the extreme forces that need to be transmitted into the bonding furnace hot zone.

Deformable structures can be bonded without the expense of the large applied forces necessary in diffusion bonding of dense structures. The expense of creating extremely flat tooling and assembly components can be reduced due to the compliance of the screened or otherwise deformable platelet. Densification to any particular level required can be accomplished through appropriate time at temperature processing at significantly reduced applied forces.

Another benefit of the invention is that the composition of the screened or printed material can be tailored for the particular region of the platelet pattern where it may be best suited. For instance, if certain regions of the platelet structure require high corrosion resistance and other regions do not, a suitable low cost alternative material may be used accordingly side by side with a higher strength material. Additionally, structures that exhibit functionally gradient properties may also be created by the process of this invention. For example, a structure may be created in which the degree of thermal conductivity varies with respect to position in the structure. Similarly, a structure with positionally varying porosity could be created in structures that are non-dense. These functionally gradient features may be created by altering the formulation of the material to be deposited, altering any force applied to the material, altering the heat applied to the material and so forth.

Other objectives and further advantages and benefits associated with this invention will be apparent to those skilled in the art from the description, examples and claims which follow.

### DETAILED DESCRIPTION OF THE FIGURES

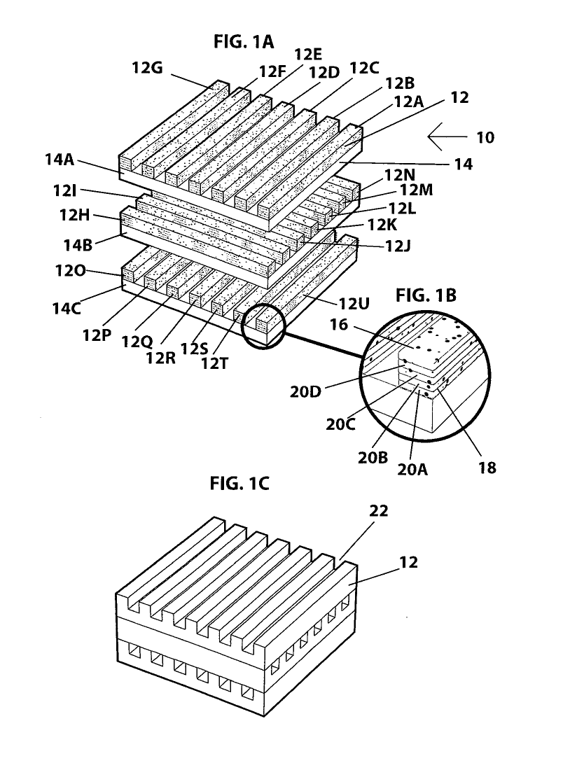

Referring to FIG. 1A, a structure having fluid flow channels, referred to generally as 10 is shown. The structure having fluid flow channels 10 could be, for example, heat sink element, chemical reactor or recuperator. One or more components of the structure having fluid flow channels 10 is created using an additive process in which deposited structures, also referred to as a structure for providing a fluid flow channel 12, are formed to a desired shape by constructing the deposited structures or structure for providing a fluid flow channel 12 layer by layer. As such, deposited structure or structure for providing a fluid flow channel 12 is created by depositing a plurality of particulates or particulate composites, or materials providing a material which are traversable between a first formable form and a second transformed form when a force is applied, onto substrate 14. As an illustrative example, deposition of the particulates or particulate composites onto the substrate 14 can be accomplished by ultrasonic 3-D printing, cold spraying or selective laser sintering (SLS), or other known means of deposition. As shown in FIG. 1A, the substrate 14 is a flat laminar element. However, such shape is not required and a substrate having other shapes or configurations can be used as well. FIG. 1A illustrates several substrates 14A, 14B, and 14C, each having a plurality of structures for providing a fluid flow channel as 12A, 12B, 12C, 12D, 12E, 12F, 12G, 12H, 12I, 12J, 12K, 12L, 12M, 12N, 12O, 12P, 12Q, 12R, 12S, 12T and 12U, and referred to generally as 12. These structures can be produced so that they may be stacked or otherwise assembled.

FIG. 1B shows a particulate grain structure 16 associated with the structure having fluid flow channels 10. The particulate grain structure 16 exists prior to a densification process and may be a result of less than full compaction of the particulates. The structure may be produced by applying a succession of layers of particulates. A knit line 18 is produced when a succeeding layer 20A, 20B, 20C, or 20D is applied to an existing layer. The particulate grain structure 16, as well as the knit lines 18, may be eliminated when the structure 12 is densified. Referring to FIG. 10, structures 12A-12U are shown after undergoing densification, resulting in passage(s) 22. Densification may be employed using a conventional diffusion bonding cycle in which a controlled force is applied to the structure in a controlled atmosphere environment. This same process can also be used to bond the stack of structures together into a single assembly. The structures for providing a fluid flow channel 12 form barriers thereby creating the fluid channels or passages 22 therebetween. While a plurality of straight fluid channels or passages 22 are illustrated, any geometrical shape may be created to form non-linear channels.

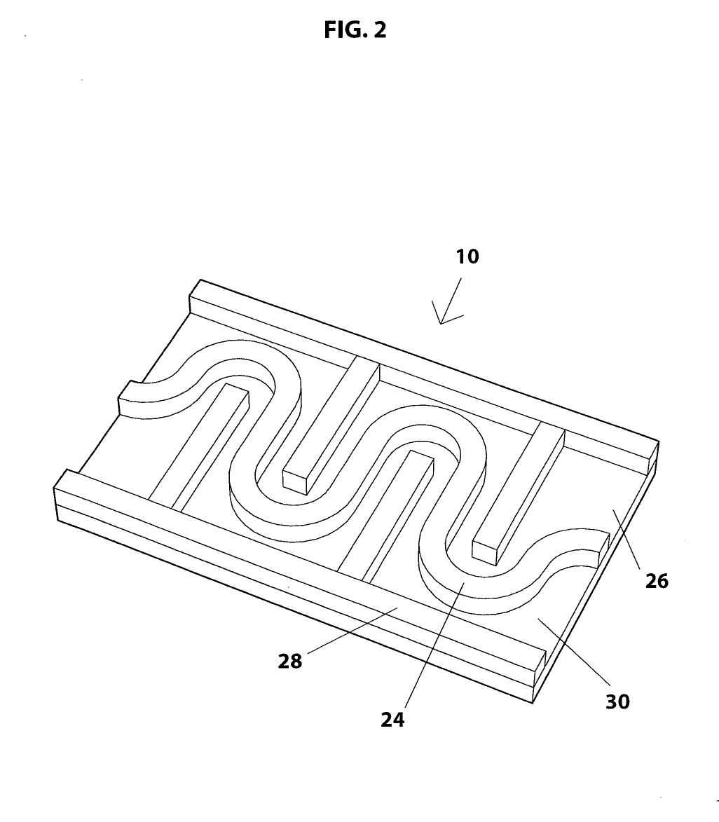

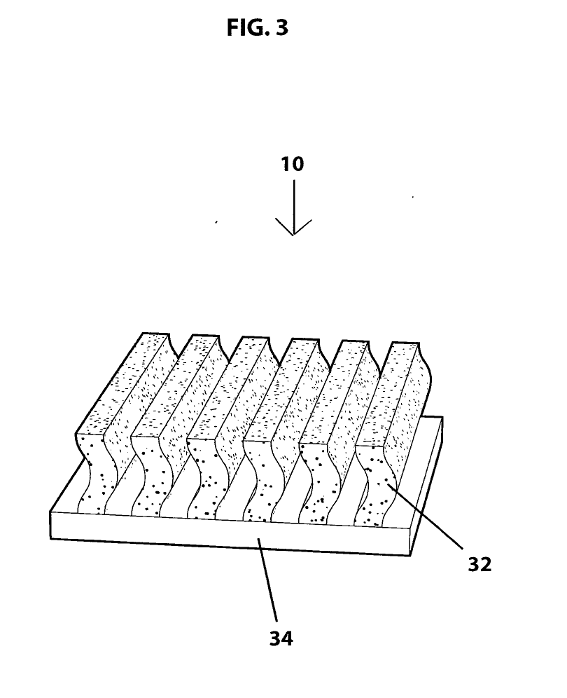

FIG. 2 illustrates the formation of a structure having fluid flow channels 10 using a wire bonding technique. The wire bonding technique is an additive process similar to that described previously to create structures, particularly 3-D structures. A wire bonding machine may be used to cause a wire 24, shown as a non-linear wire and creating a curvature, to be bonded to the substrate 26 in a predetermined pattern. The non-linear wire 24 is typically fed to the substrate 26 and bonded, such as by welding, to the substrate 26 in an automatic and simultaneous process. A linear bonded wire 28 can be used in areas of the structure 10 when a barrier or other non-curving structure is desired. The wire 28 may be applied either in a continuous application or in segments. As illustrated in FIG. 2, the non-linear wire 24 and the linear bonded wire 28 provide passage(s) 30. Passage 30 is created by the space between the non-linear wire 24 and the linear bonded wire 28. The bonding process can be followed by a soldering, brazing or other bonding process if desired to more fully bond the wire to the substrate. A top plate (not shown) may be applied to the structure to provide a lid or cover. Alternatively, the structure 10 may be bonded to similarly constructed structures.

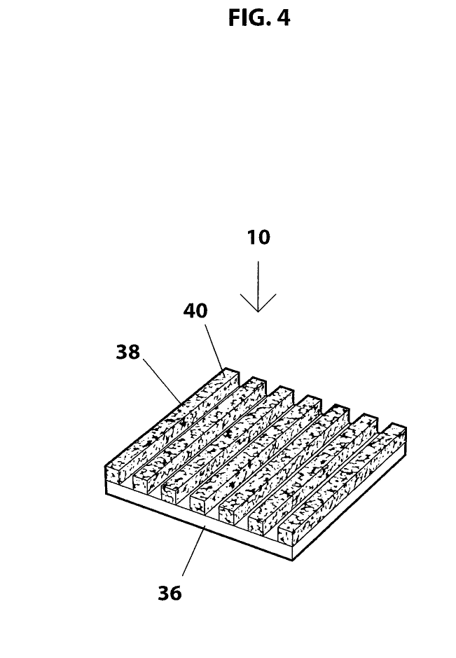

While each layer of the deposition applied in FIG. 1A forms a uniform structure, i.e. each layer is essentially the same size and is positioned directly above the preceding layer, such configuration need not be the case. The structure having fluid flow channels 10 can be formed as non-uniform structures. FIG. 3 illustrates a structure having fluid flow channels 10 comprising a fluid flow channel 32 formed by adjacent layers aligned using off-set layers. Each adjacent layer is positioned on the preceding layer so as to not be directly above. The degree of the off-set alignment or positioning of the adjacent layer determines the structure or degree of curvature wanted. The layers are bonded to substrate 34. So long as the offset is sufficiently small, conventional diffusion bonding processes may be employed to apply force to the structure during the bonding process.

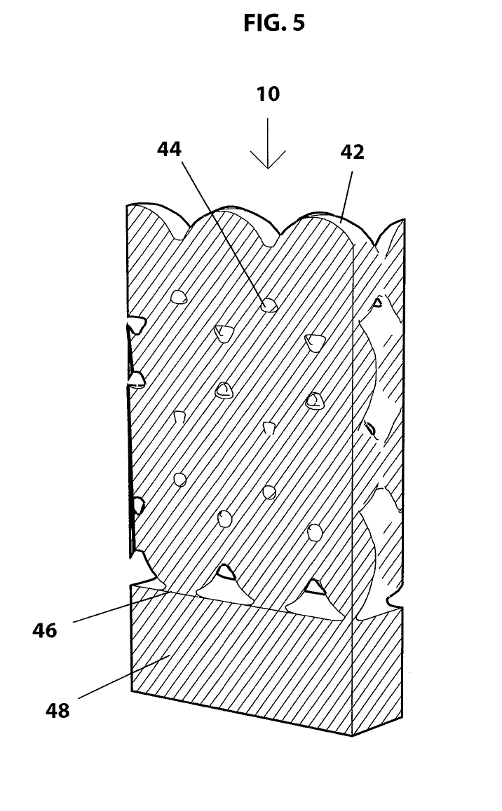

FIG. 4 shows the structure having fluid flow channels constructed using one or more layers of a silk-screened material. In this manner, a slurry, paste or other material is applied to a substrate 36 to produce the structure for providing a fluid flow channel 38. Structure 38 is similar to the previously described structure for providing a fluid flow channel 12. If the material is not sintered, or otherwise densified, it will be porous in nature containing small voids 40. The small voids 40 within the structure provide a path of fluid flow in-between each of the structure for providing a fluid flow channel 38. The degree of porosity or the number or size of the voids can be varied depending on the characteristics required. If desired, after forming, the structure for providing a fluid flow channel 38 may be sintered to more strongly bond together the particulates within the structure. This process can also simultaneously form a bond between the substrate 36 and the structure for providing a fluid flow channel 38. This single step process is beneficial as it saves time and money.

FIG. 5 shows a sintered structure similar to the structure shown in FIG. 4. In the structure shown in FIG. 5 the sintering process does not completely fill the interstitial spaces between the particulates of the structure. In this structure, particulates 42 are bonded together to form a structure 10 having voids 44. The structure 10 is sintered or otherwise processed to create a bond 46 between the structure 10 and a substrate 48. Such a structure can be achieved by sintering with or without an interface bonding agent such as a low melting braze material. If it is desired that the structure be non-porous, a surplus of the braze material can be employed so that, when melted, it will completely fill the interstitial spaces 44 between the particulates 42. This can be accomplished in the same process as the sintering steps. Alternatively, the operation can be achieved in a post-sintering operation. The present invention can provide for a 3-D structure of controlled porosity. In this case the particle size and particle size distribution of the particulate is carefully chosen, as is the type and quantity of braze material, if any. The sintering temperature and time at temperature can be carefully controlled so that resulting porosity is predictable and as desired.

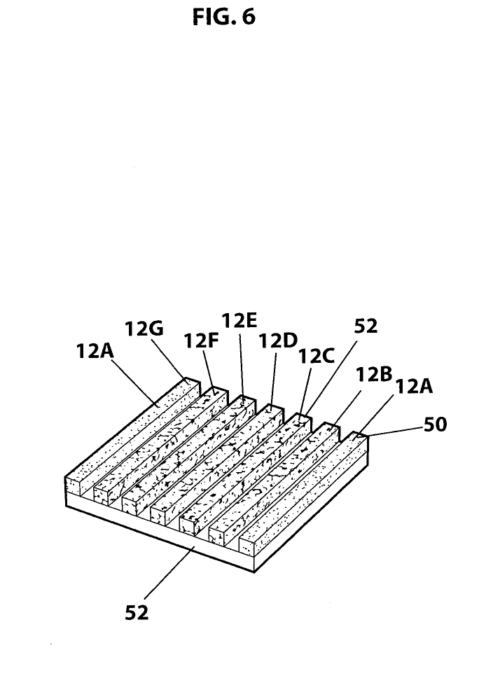

FIG. 6 illustrates the structure having fluid flow channels 10 having unique features. The structure for providing a fluid flow channel 12A-12G are formed as described previously, i.e. layer by layer. In addition, the structure 10 is designed to contain a dense formation (represented 12A and 12G), which forms peripheral walls, and porous structures (represented by 12b-12F), which form internal structures. The structures of differing density or porosity can be produced by applying pastes or slurries of differing properties as described in the specification. These pastes or slurries may be applied sequentially or simultaneously, and may be applied by a silk screen process, pad printing, lithographically, xerographically, by means of anilox rollers or other known means. In this construction, structures 12A and 12G (dense structures) prevent fluid from leaking out of the structure having fluid flow channels 10. Structures 12B-12F are more porous and allow fluid to travel in-between such structures.

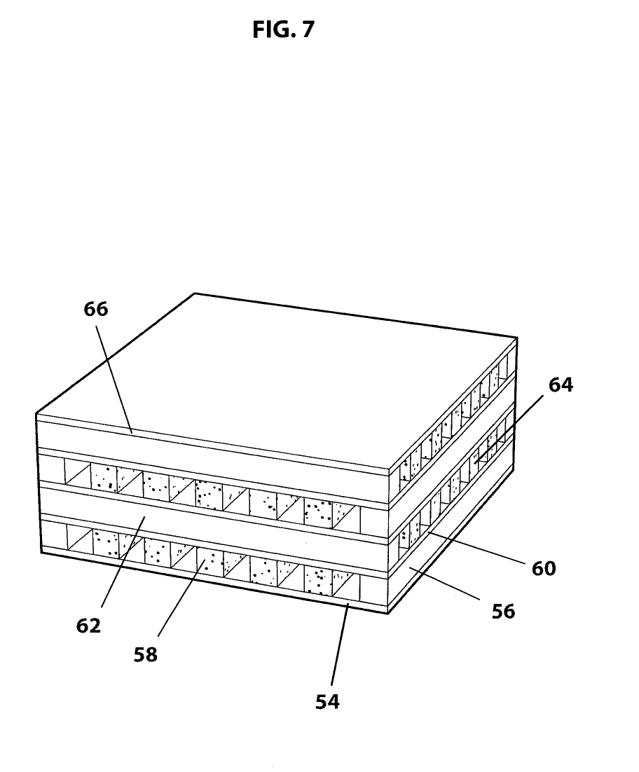

FIG. 7 illustrates the structure having fluid flow channels 10 fabricated by a 3-D printing. A featureless sheet has printed upon it, or applied to it, a first deposit material 56, such as but not limited a metal, ceramic or glass. The first deposit 56 may be a non-porous, thermally conductive material. A second deposit 58 may be applied that may comprise a highly thermally conductive material. A second featureless sheet 60 is positioned on top of first deposit 56 and second deposit 58. A third deposit 62, for example a corrosion resistant material, is applied to the second sheet 60. A fourth deposit 64, such as a corrosion resistant material is also applied to second sheet 60. This process may be repeated as many times as is desired to create the 3-D assembly. A lid or cover, 66 is then applied as the final layer of the structure. The assembly is then bonded by diffusion bonding, modified diffusion bonding or other suitable processes. The resulting structure may be employed as a cross-flow heat exchanger in which the “wetted” internal passages of the exchanger offer either high thermal conductivity or a high degree of corrosion resistance. If desired, first deposit 56, third deposit 62 and the like, may be fully dense “stop blocks” that assure that each layer crushes to a predetermined point during diffusion bonding or other processes. This is very useful to keep the stack in the form of a right solid, that is, with each face orthogonal to another and opposite faces parallel. The structure having fluid flow channels 10 shown can be designed so that one or more components have different characteristics.

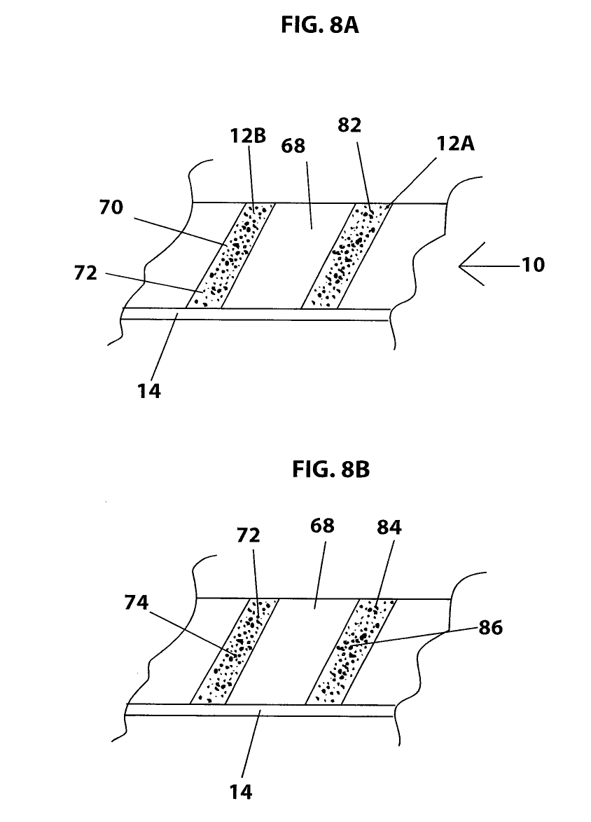

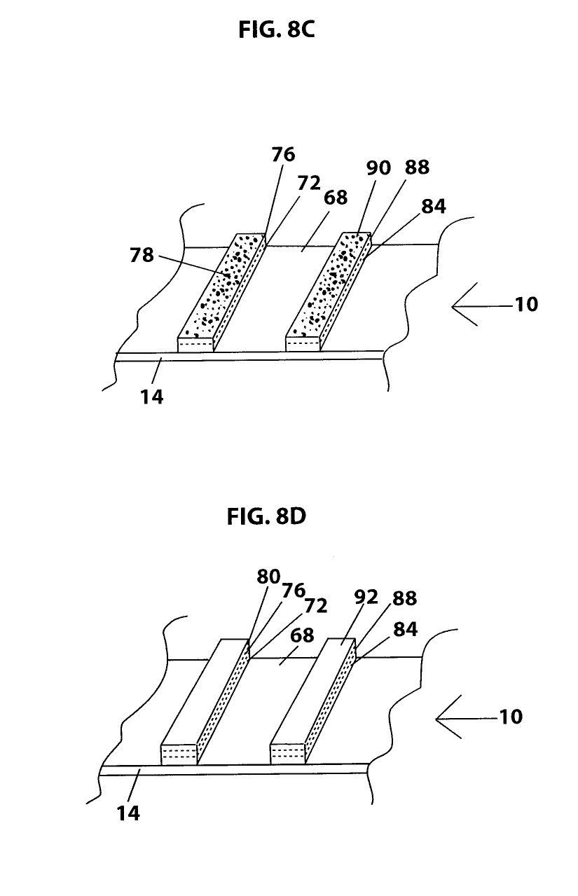

FIGS. 8A-8D further illustrates the method of forming a structure having fluid flow channels 10. Each of the figures represents a partial view of the structure having fluid flow channels 10, showing the formation of two structures for providing a fluid flow channel 12. In the illustration, the fluid flow channels are representative of fluid flow channels 12A and 12B. However, any fluid flow channel described herein can be formed accordingly. The structure having fluid flow channels 10 can be constructed by providing the substrate 14. The substrate 14 has at least a first surface 68 for receiving and supporting one or more of the structures configured to form fluid flow channels 12A and 12B. A first structure which provides a fluid flow channel (12A) is formed using several additive steps, including using a first material 70 configured to form a first structure which provides a fluid flow channel. The first material 70 is shown in a particle form, however, other forms such as powders, slurries, a structure having particles of pressed material, fibers, or wire may be used as well. The material 70 may be uniform, i.e. be comprised of the same material. For example, the material may be copper. Alternatively, the material may be made of two or more materials. For example, a mixture of copper and nickel may be used. The first material configured to form a first structure which provides a fluid flow channel is placed onto said first surface 68 of substrate 14, see FIG. 8A. The first material 70 can be arranged on the substrate 14 in a predetermined orientation, whereby the predetermined arrangement forms a component of the first structure which provides a fluid flow channel 12A. The first material 70 can be secured by, for example, bonding to the substrate 14. This forms a first layer 72.

The size, shape and other characteristics of the first structure which provide a fluid flow channel 12A can be created by adding additional layers to the first layer 72. To build successive layers, at least one second material 74 is used to form additional components of said first structure which provides a fluid flow channel 12A. Material 74 may be the same as or a different material as material 70. The at least one second material 74 is placed or arranged in an predetermined orientation on, or next to the previously formed layer, layer 72. The at least one second material 74 is secured to layer 72 to form another layer 76, see FIG. 8C. Layer 72 and 78 form a structure by using, for example, a sintering process or any other mechanism or procedure known to one of skill in the art which forms a solid mass. Additional materials 78 may be placed on the first structure which provides a fluid flow channel 12A comprised of layers 72 and 74, see FIG. 8C, and processed as described above. This results in the first structure which provides a fluid flow channel 12A formed by three layers 72, 76, and 78. The number of layers created, the arrangement upon adjacent layers, and the type of material or size of particles used determines the nature (such as but not limited to the size, shape, physical properties such as heat conductivity, porosity) of the first structure which provides a fluid flow channel 12A.

As shown in FIG. 1, the structure having fluid flow channels 10 contains multiple structures which provide a fluid flow channel 12. Referring back to FIG. 8A, a second structure which provides a fluid flow channel 12B can be formed by using several additive steps, including using a first material configured to form a second structure 82 which provides a fluid flow channel 12B. The second material configured to form a second structure 82 can be the same as or a different material as materials 70 or 78. The first material configured to form a second structure which provides a fluid flow channel 82 is placed onto the first surface 68 of substrate 14, see FIG. 8A.

The first material configured to form a second structure which provides a fluid flow channel can be arranged on the substrate 14 in a predetermined orientation, whereby the predetermined arrangement forms a component of the second structure which provides a fluid flow channel 12B. The first material configured to form a second structure which provides a fluid flow channel 82 can be secured by, for example, bonding, sintering or any other mechanism or procedure known to one of skill in the art which form a solid mass, to the substrate 14. This forms a first layer 84, see FIG. 8B.

The size, shape and other characteristics of the second structure which provides a fluid flow channel 12B can be created by adding additional layers to the first layer 84. To build successive layers, at least one second material configured to form a second structure which provides a fluid flow channel 86 is used to form additional components of the second structure which provides a fluid flow channel 12B. Material 86 may be the same as or a different material as those materials previously described. The at least one second material configured to form a second structure which provides a fluid flow channel 86 is placed or arranged in a predetermined orientation on, or next to the previously formed layer, layer 84. The at least one second material configured to form a second structure which provides a fluid flow channel 86 is secured to base layer 84 to form another layer 88, see FIG. 8C. Additional materials configured to form a second structure which provides a fluid flow channel 90 may be placed on the second structure which provides a fluid flow channel 12B comprised of layers 84 and 88, see FIG. 8C, and processed as described above, i.e. using a sintering process, or any other mechanism or procedure known to one of skill in the art which form a solid mass. This results in the second structure which provides a fluid flow channel 12B formed by three layers 84, 88, and 90. The number of layers created, the arrangement upon adjacent layers, and the type of material used determines the nature (such as but not limited to the size, shape, physical properties such as heat conductivity, porosity) of the second structure which provides a fluid flow channel 12B. While the formation of the first structure which provides a fluid flow channel 12A and the second structure which provides a fluid flow channel 12B is described individually, such formation may be accomplished simultaneously.

Depending on the forming processes, i.e. the sintering process and the characteristics of the material used, the structures can be created having different characteristics or properties. For example, the structure which provides a fluid flow channel 12 can be formed having a greater density than adjacent structures which provide a fluid flow channel 12 (i.e. 12A vs. 12B vs. 12C. Density of these structures can be controlled, for example, by the size of material used and by the manipulation of the formation process, i.e. degree of sintering. Moreover, since the structure which provides a fluid flow channel 12 is created layer by layer, an individual structure which provides a fluid flow channel 12 (i.e. 12A) may contain a first layer that is more or less dense than adjacent or successive layers. In addition, each fluid structure which provides a flow channel 12 (i.e. 12A vs. 12B vs. 12C) can be designed to have different porosities or percentage of void spaces. This may be accomplished by, for example, controlling or selecting the size and shape of the materials used. As described for density, an individual structure which provides a fluid flow channel 12 may be constructed so that each layer has a different porosity. Manipulation of these features allows for diverse structures, both internally, (i.e. layer by layer) and with respect to adjacent structures. Moreover, the diversity of the structures can be changed rapidly and easily.

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of constructing a device having one or more fluid flow channels using an additive procedure comprising the steps of:
providing a material traversable between a first formable form and a second transformed form, said material traversable from said first formable form to said second transformed form when a force is applied;
arranging said material having said first formable form into an orientation;
converting said material having said first formable form to said material having a second transformed form thereby forming a first layer of a first fluid flow structure;
adding a first additional material to said first layer, said additional materials being added to said first layer in a first formable form; and
converting said first additional material from a first formable form to a second transformed form, whereby said second transformed form bonds to said first layer thereby forming an additional component of said first fluid flow structure.

2. The method of constructing a device having one or more fluid flow channels using an additive procedure according to claim 1 further including the steps of:
adding at least one second additional material traversable between a first formable form and a second transformed form to said fluid flow structure; said second additional material being added to said fluid flow structure in a first formable form;
converting said second additional material from a first formable form to a second transformed form, whereby said second transformed form bonds to said first fluid flow structure.

3. The method of constructing a device having one or more fluid flow channels using an additive procedure according to claim 1 wherein said at least one material traversable between a first formable form and a second transformed form and said first additional material is the same material.

4. The method of constructing a device having one or more fluid flow channels using an additive procedure according to claim 2 wherein said one material traversable between a first formable form and a second transformed form, said first additional material, and said at least one second material are the same material.

5. The method of constructing a device having one or more fluid flow channels using an additive procedure according to claim 3 wherein at least one of said one material traversable between a first formable form and a second transformed form, said first additional material, and said at least one second material is a different material.

6. The method of constructing a device having one or more fluid flow channels using an additive procedure according to claim 1 wherein said step of adding at least one second additional material traversable between a first formable form and a second transformed form to said fluid flow structure results in formation of a uniformly shaped fluid flow structure.

7. The method of constructing a device having one or more fluid flow channels using an additive procedure according to claim 1 wherein said step of adding at least one second additional material traversable between a first formable form and a second transformed form to said fluid flow structure results in formation of a non-uniformly shaped fluid flow structure.

8. The method of constructing a device having one or more fluid flow channels using an additive procedure according to claim 7 wherein said step of forming a non-uniformly shaped fluid flow structure includes orientating at least one of said one material traversable between a first formable form and a second transformed form, said first additional material, and said at least one second material in an offset position relative to an adjacent said one material traversable between a first formable form and a second transformed form, said first additional material, or said at least one second material.

9. The method of constructing a device having one or more fluid flow channels using an additive procedure according to claim 2 wherein said one material traversable between a first formable form and a second transformed form, said first additional material, and said at least one second material are powders, granules, particulate form, or combinations thereof.

10. A method of constructing a device having multiple fluid flow channels formed by an additive procedure comprising the steps of:
providing a substrate, said substrate having at least a first surface for receiving and supporting two or more structures configured to form fluid flow channels;
forming a first structure which provides a fluid flow channel by:
using a first material configured to form a first structure which provides a fluid flow channel;
placing said first material configured to form a first structure which provides a fluid flow channel onto said first surface of said substrate,
arranging said first material configured to form a first structure which provides a fluid flow channel on said base layer in a predetermined orientation, whereby said predetermined arrangement forms a component of said first structure which provides a fluid flow channel;
securing said first material configured to form a first structure which provides a fluid flow channel to said substrate;
using at least one second material to form additional components of said first structure which provides a fluid flow channel;
arranging said at least one second material in a predetermined orientation on or next to said previously formed layer;
securing said second material configured to form a first structure which provides a fluid flow channel to said substrate;
forming at least one second structure which provides a fluid flow channel by:
using a first material configured to form a second structure which provides a fluid flow channel;
placing said first material configured to form a second structure which provides a fluid flow channel onto said first surface of said substrate,
arranging said first material configured to form a second structure which provides a fluid flow channel on said base layer in a predetermined orientation, whereby said predetermined arrangement forms a component of said second structure which provides a fluid flow channel;
securing said first material configured to form a second structure which provides a fluid flow channel to said base layer;
using at least one second material to form additional components of said second structure which provides a fluid flow channel;
arranging said second material configured to form a second structure which provides a fluid flow channel on said substrate in a predetermined orientation, whereby said predetermined arrangement forms a component of said second structure which provides a fluid flow channel;
securing said second material configured to form a second structure which provides a fluid flow channel to said previously formed second structure.

11. The method of constructing a device having one or more fluid flow channels using an additive procedure according to claim 10 further including the step of forming an additional structure which provides a fluid flow channel by:
using a first material configured to form an additional structure which provides a fluid flow channel;
placing said first material configured to form an additional structure which provides a fluid flow channel onto said first surface of said base layer,
arranging said first material configured to form an additional structure which provides a fluid flow channel on said base layer in a predetermined orientation, whereby said predetermined arrangement forms a component of said additional structure which provides a fluid flow channel;
securing said first material configured to form an additional structure which provides a fluid flow channel to said base layer;
using at least one second material to form additional components of said additional structure which provides a fluid flow channel;
arranging said at least one second material in a predetermined orientation on said previously formed additional structure;
securing said second material configured to form an additional structure which provides a fluid flow channel to said previously formed additional structure.

12. The method of constructing a device having one or more fluid flow channels using an additive procedure according to claim 10 wherein said first material configured to form a first structure, said second material configured to form a first structure, said first material configured to form a second structure, and said second material configured to form a second structure are the same.

13. The method of constructing a device having one or more fluid flow channels using an additive procedure according to claim 10 wherein at least one of said first material configured to form a first structure, said second material configured to form a first structure, said first material configured to form a second structure, and said second material configured to form a second structure is different.

14. The method of constructing a device having one or more fluid flow channels using an additive procedure according to claim 10 wherein said first structure or said second structure are uniformly shaped.

15. The method of constructing a device having one or more fluid flow channels using an additive procedure according to claim 10 wherein said first structure or said second structure are non-uniformly shaped.

16. The method of constructing a device having one or more fluid flow channels using an additive procedure according to claim 10 wherein said first structure and said second structure have different densities or porosity.

17. The method of constructing a device having one or more fluid flow channels using an additive procedure according to claim 10 wherein said first structure or said second structure have regions of differing density.

18. The method of constructing a device having one or more fluid flow channels using an additive procedure according to claim 10 wherein said first structure or said second structure have regions of different porosity.

19. The method of constructing a device having one or more fluid flow channels using an additive procedure according to claim 10 wherein said first structure or said second structure are made from at least two different materials.
